(19) United States
(12) Patent Application Publication
(10) Pub. No.: US 2021/0114403 A1
(43) Pub. Date: Apr. 22, 2021

(54) FASTENER RETAINER

(71) Applicant: INFINITE CONCEPTS & MANUFACTURING, Waynesville, OH (US)

(72) Inventors: Chris A. Pickrell, Tipp City, OH (US); Timothy S. Stover, Waynesville, OH (US)

(21) Appl. No.: 17/076,642

(22) Filed: Oct. 21, 2020

Related U.S. Application Data
(60) Provisional application No. 62/923,752, filed on Oct. 21, 2019.

(51) Int. Cl. B60B 7/04; B60B 7/14

(52) U.S. Cl. CPC B60B 7/04; B60B 7/0013; B60B 7/14

(57) ABSTRACT

A fastener retainer includes at least one fastener cap and a hub. Each fastener cap can include a stop channel that encircles a bottom portion of a housing of the fastener cap, a base with cog members that encircle the housing, or a combination thereof. The hub has at least one port therein, where each port is associated with a corresponding fastener cap. At least one locking member is positioned on the hub. For instance, a locking member can be provided adjacent to each port. In use, each locking member constrains radial movement of a corresponding fastener cap inserted into the associated port, by disposing a projecting member into a space between adjacent cog members on the base of the corresponding fastener cap.

### CROSS REFERENCE TO RELATED APPLICATIONS

This application claims the benefit of U.S. Provisional Patent Application Ser. No. 62/923,752, filed Oct. 21, 2019, entitled MODULAR TIRE SYSTEM, the disclosure of which is hereby incorporated by reference.

### BACKGROUND

Various aspects of the present disclosure relate generally to a fastener retainer, and more specifically to a fastener retainer that is particularly adaptable to retain fasteners such as lug nuts on a tire system.

Vehicles and other over-the-road structures typically rely upon wheels to facilitate movement. Briefly, a wheel hub assembly includes a hub having a hub flange, and threaded studs (referred to as lugs) that extend outward from the hub flange. The lugs extend in a pattern that aligns with lug openings in a corresponding wheel rim. The wheel rim mounts against the wheel hub such that each lug projects through a corresponding lug opening in the rim. Lug nuts tighten against the rim, thus securing the wheel rim to the wheel hub assembly. A tire is mounted to the rim and is typically inflated with air or other suitable gas.

### BRIEF SUMMARY

According to aspects of the present disclosure, a fastener retainer comprises a fastener cap and a hub. The fastener cap comprises a housing having an internal cavity that dimensionally corresponds to a fastener. The fastener cap also includes a stop channel that encircles a portion of the housing, and a base that encircles the housing. The base further comprises a first cog member, a second cog member, and a spatial gap in between the first cog member and the second cog member. The hub includes a port that receives the fastener cap. The hub further comprises a locking member that constrains radial movement of the fastener cap by a projecting member disposed in the spatial gap.

According to further aspects of the present disclosure, a fastener retainer comprises a hub having an array of ports, and an array of fastener caps that numerically correspond to the array of ports. Each fastener cap in the array of fastener caps comprises a housing sized to cooperate with an associated one of the ports in the array of ports of the hub, and the fastener cap further comprises a base that encircles the housing. The base further comprises a first cog member, a second cog member, and a spatial gap in between the first cog member and the second cog member. The fastener retainer also includes an array of locking members that numerically correspond to the array of fasteners caps, where each locking member in the array of locking members is coupled to the hub adjacent to an associated port. Moreover, each locking member constrains radial movement of a corresponding fastener cap by disposing a projecting member in a spatial gap between the first cog member and the second cog member on the base of the corresponding fastener cap.

According to still further aspects of the present disclosure, a fastener retainer for a tire comprises a hub having at least four ports, at least four fastener caps, and a fastener cap uniquely associated with each of the at least four ports. Here, each fastener cap comprises a housing that inserts into the corresponding one of the at least four ports, a stop channel that encircles the housing, and a base that encircles the housing. Cog members project from each fastener cap base, where pairs of adjacent cog members are separated by a space. Additionally, a locking member is uniquely associated with each of the at least four ports. Each locking member constrains radial movement of a corresponding fastener cap by disposing a projecting member into a select spatial gap between adjacent cog members. Also, a stop lever is coupled to the hub that engages the stop channel of a corresponding fastener cap, thereby constraining translational movement thereof. In some embodiments, there are at least four stop levers, a stop lever adjacent to each port in the hub.

According to yet further aspects of the present disclosure, a fastener retainer is disclosed. The fastener retainer utilizes one or more fastener caps (e.g., one, two, four five, six, eight, ten, etc., total fastener caps). Each fastener cap has a housing with an internal cavity that dimensionally corresponds to fit over a lug nut of a vehicle tire. Further, each fastener cap has a stop channel and a base that encircles the housing. The base includes cog members (e.g., gears, teeth, etc.) that have a spatial gap in between the cog members.

The fastener retainer also includes a hub having a port for each fastener cap of the fastener retainer (multiple ports in instances where multiple fastener caps are used). Here, each port receives a corresponding fastener cap. The hub further includes a locking member adjacent to each port, (thus multiple locking members in instances where multiple fastener caps are used). Each locking member constrains radial movement of an associated fastener cap by disposing a projecting member into a spatial gap between cog members of the associated fastener cap.

The locking members can be implemented in multiple ways. For instance, the locking members can be implemented as a “pawl” (e.g., ratchet) or “dog” depending on how the cog members are configured. In configurations where the cog members are at an offset angle, a pawl or ratchet configuration may be utilized so that the fastener can be further tightened if needed. Positionally, the locking members can be disposed on an outside surface of the hub or recessed within the hub, e.g., and held in place by a pin.

The hub can also include a stop lever that engages the stop channel of the fastener cap, thereby constraining translational movement of the fastener cap. For example, the stop channel can be implemented as a recessed channel that the stop lever can slot into.

Aspects of the present disclosure also provide for multiple configurations of the hub and fastener caps. For instance, the hub can be shaped as a disc with fastener caps arranged in an array on a circumference of the hub, which may be well suited to secure lug nuts on a vehicle wheel. Additional configurations are described in greater detail herein.

### BRIEF DESCRIPTION OF THE SEVERAL VIEWS OF THE DRAWINGS

FIG. 1 is a perspective view of a fastener retainer according to various aspects of the present disclosure as described in greater detail herein;

FIG. 2A is a perspective view of a fastener cap for use with the fastener retainer of FIG. 1 according to various aspects of the present disclosure as described in greater detail herein;

FIG. 2B is a perspective view of an alternative fastener cap for use with the fastener retainer of FIG. 1, which is illustrated as a two individual components, according to various aspects of the present disclosure as described in greater detail herein;

FIG. 3 is a bottom-up view of a hub of the fastener retainer of FIG. 1 according to various aspects of the present disclosure as described in greater detail herein;

FIG. 4A is a close-up view of a locking member for use with the fastener retainer of FIG. 1 according to various aspects of the present disclosure as described in greater detail herein;

FIG. 4B is a close-up view of a locking member for use with the fastener retainer of FIG. 1 according to further aspects of the present disclosure as described in greater detail herein;

FIG. 5A is a perspective view of the fastener retainer of FIG. 1 in an unlocked position according to various aspects of the present disclosure as described in greater detail herein;

FIG. 5B is a perspective view of the fastener retainer of FIG. 1 in a locked position according to various aspects of the present disclosure as described in greater detail herein;

FIG. 6 is a front view of the fastener retainer of FIG. 1 according to various aspects of the present disclosure as described in greater detail herein;

FIG. 7A and FIG. 7B illustrate perspective views of a hub cap assembly according to various aspects of the present disclosure as described in greater detail herein, where FIG. 7A illustrates the hub cap assembly from the top, and FIG. 7B illustrates the hub cap assembly from the bottom;

FIG. 8 is a perspective view of an embodiment of the hub cap assembly of FIG. 7A and FIG. 7B according to various aspects of the present disclosure as described in greater detail herein; and

FIG. 9 is a perspective view of a modular tire system according to various aspects of the present disclosure as described in greater detail herein.

### DETAILED DESCRIPTION

Until technology allows otherwise, one reality of motor vehicle ownership is that wheels (e.g., tires) need to be replaced every so often. Replacement may be warranted from high mileage, elemental wear and tear (e.g., high heat), and road hazards. With just few fasteners (e.g., lug nuts), it is possible to take a wheel off a vehicle and place a new wheel on the vehicle within minutes.

While fasteners are convenient, there is a potential negative outcome associated with failure of fasteners. The lug nuts that couple the wheel to the vehicle can also “back out” (i.e., come loose) over time due to vibrations from operation of the vehicle and other external factors. If the wheel comes off the vehicle while the vehicle is in motion, an accident may occur.

Moreover, in certain industries such as shipping, where semi-trucks and larger vehicles are used, a loose or detached wheel can have an even more profound negative outcome. On older semi-trucks, lug nuts tend to be exposed, which allows a semi-truck driver to inspect the lug nuts. However, some semi-trucks use hub caps to reduce drag and increase fuel efficiency, but hub caps conceal the lug nuts, making inspection more difficult because the hub cap would need to be removed for inspection of the lug nuts.

Accordingly, aspects of the present disclosure are directed toward fastener retainers. In some embodiments, the fastener retainers are particularly suited or otherwise adaptable for use with tire systems to reduce or eliminate the lug nuts from backing out, thereby obviating the need to remove the hub cap to check on the lug nuts.

In this regard, aspects of the present disclosure are further directed toward a hub cap assembly that leverages the advantages granted by the fastener retainer to provide further benefits to those in the transportation industry as described in greater detail herein.

As described in greater detail herein, the fastener retainers and the hub cap assembly can be implemented together to form a modular tire system that utilizes benefits of each component as well as provide synergistic benefits to the user.

While aspects of the present disclosure frequently refer to the fastener retainer in the context of a vehicle wheel, aspects of the present disclosure have applicability that extends beyond vehicle wheels. For instance, other machines that have fasteners that can back out and lead to accidents include amusement park rides, industrial machines, heavy equipment, etc.

Fastener Retainer

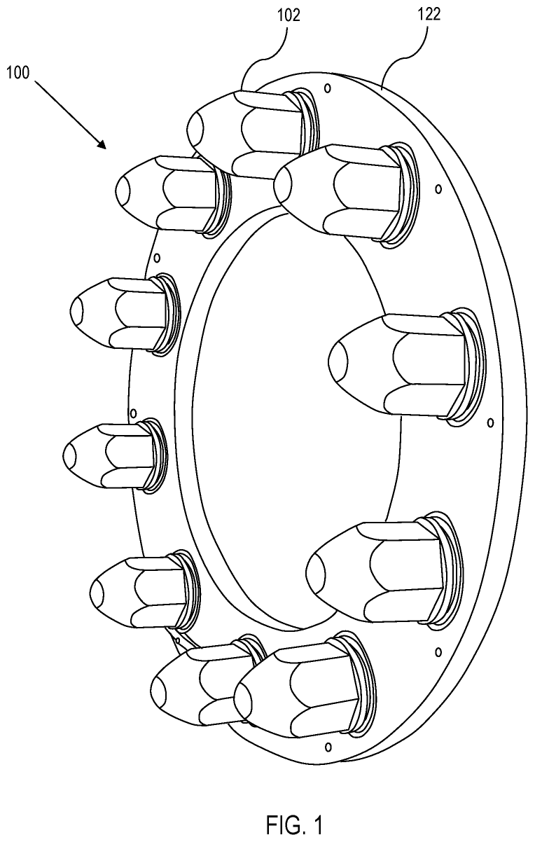

Referring to drawings and in particular FIG. 1, a fastener retainer 100 is illustrated according to aspects of the present disclosure, in a form factor that is particularly adapted for use with a tire system. In general, the fastener retainer 100 comprises a fastener cap 102 and corresponding hub 122. Since the example embodiment is for a tire system, the hub 122 is illustrated as an annular ring sized and dimensioned to align with lugs of a corresponding tire system, as will be described in greater detail herein.

In general, the fastener retainer 100 can utilize more than one fastener cap 102. Likewise, the hub 122 can take on any desired shape, e.g., depending upon the intended application. For instance, a fastener retainer 100 can include a set (i.e., a plurality) of fastener caps 102. In a practical embodiment such as for use with a tire system, the set of fastener caps 102 may be implemented so as to form a ring-shaped array when brought into cooperation with the hub 122. In this regard, aspects of the present disclosure allow for embodiments that comprise one, two, four, five, six, eight, ten, or more fastener caps 102 depending how many fasteners need to be retained as described in greater detail herein. Of course, other quantities of faster caps 102 may also be implemented, depending upon the application. By way of example, a typical wheel that includes ten lug bolts and ten corresponding lug nuts may utilize a fastener retainer 100 that includes a hub 122 defining an annular ring having ten ports therein to align with the ten lug bolts and ten corresponding fastener caps 102. In this regard, the ports are utilized to position and/or locate the fastener caps 102 relative to the hub 122.

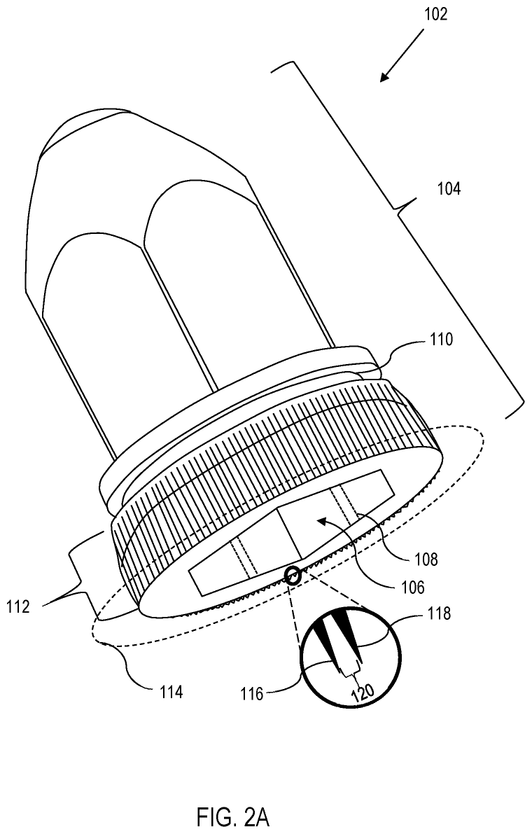

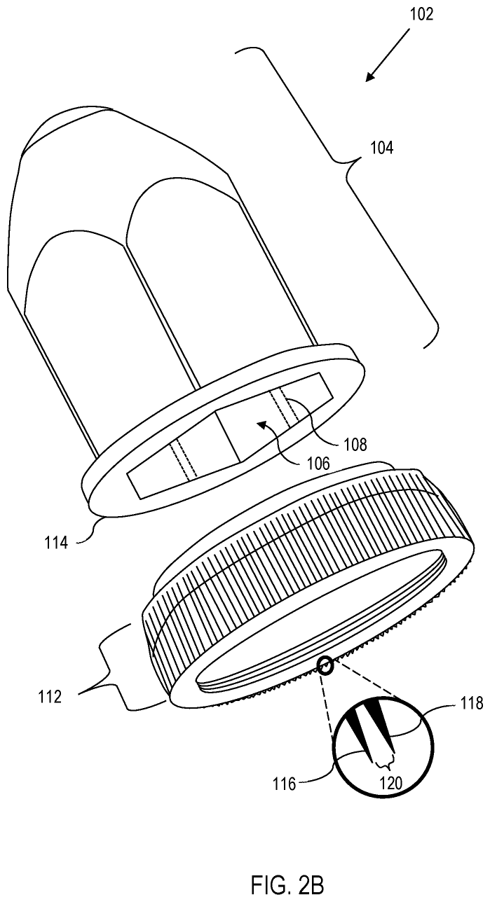

Referring now to FIG. 2A, a detailed perspective view illustrates an example instance of a fastener cap 102 (e.g., fastener cap 102—FIG. 1). As such, like structure is illustrated with like reference numbers.

The illustrated fastener cap 102 comprises a housing 104 having an internal cavity 106 that dimensionally corresponds to a fastener. For example, if a user needs to secure (or retain) a lug nut with six sides, the internal cavity 106 of the housing 104 can be adapted to fit or otherwise seat over that six-sided lug nut. Analogously, by way of additional examples, the fastener cap 102 can be adapted to fit various diameters of lug nuts (e.g., 8 mm (millimeters), 9 mm, 10 mm, etc.). Alternatively, a fastener cap 102 can seat over a bolt head or other fastener. In this regard, the fastener cap 102 can push onto a corresponding lug nut or other fastener, and secure thereto, such as by a friction fit. In other embodiments, the fastener cap 102 may threadably screw on, snap onto, clip onto or otherwise secure to a corresponding fastener. Still further, the fastener cap 102 in some embodiments can replace a nut, e.g., by including internal threads that thread onto a corresponding bolt. Thus, in some embodiments, the fastener caps 102 can serve as lug nuts that mate with corresponding lug bolts.

In various embodiments, the internal cavity 106 further comprises extruded channels 108 that extend vertically along the internal cavity 106. The extruded channels 108, where utilized, provide additional grip on a corresponding lug nut, bolt head, or other form of fastener when such a corresponding lug nut (or other suitable fastener) is inserted into the internal cavity 106.

Compositionally, the fastener cap 102 may comprise polymers (e.g., plastics, fiber-filled plastic nylon, etc.), metals, minerals (e.g., onyx), etc., or combinations thereof.

The fastener cap 102 may include a stop channel 110 that encircles the housing 104. For instance, as illustrated, the stop channel 110 encircles a portion of the housing 104, e.g., towards the bottom. In practice, the stop channel 110 can be used to cooperate with a securement on the hub (discussed in greater detail herein) to constrain translational movement of the hub 122 relative to the fastener cap 102, e.g., to secure the hub 122 to a tire assembly via the fastener caps 102. Thus, the stop channel 110 can serve as a locking mechanism in cooperation with the hub 122 (FIG. 1) to retain or otherwise lock the hub relative to a corresponding fastener cap 102.

In the illustrated embodiment, the fastener cap 102 also comprises a base 112 that encircles the housing 104. For instance, as illustrated, the base 112 encircles a bottom portion of the housing 104, e.g., below the stop channel 110. As illustrated in FIG. 2A, in various embodiments the base 112 can include an extruded portion 114 as indicated by the dashed circle. In practice, the extruded portion 114 is a solid piece, but for visual clarity of other components in FIG. 2A, the extruded portion is shown as transparent. The extruded portion 114 can thus define a brim or flange that can create an abutment surface, e.g., for aligning the hub 122 (FIG. 1).

On a periphery of the base 112 is a first cog member 116, a second cog member 118, and a spatial gap 120 in between the first cog member 116 and the second cog member 118. In practice, the first cog member 116 and the second cog member 118 extend away from the base 112 and away from the internal cavity 106 as shown in greater detail herein.

In an example embodiment, the first cog member 116 and the second cog member 118 extend from the base 112 radially (i.e., not pointing at a particular angle). In other example embodiments, the first cog member 116 and second cog member 118 extend from the base 112 at an offset angle (or a predetermined angle, e.g., 45 degrees, 30 degrees, etc.), to enable use of the cog members as a ratcheting mechanism as described in greater detail herein.

In practice, the base 112 may utilize more than two cog members, as shown in FIG. 2A. In this regard, the number of cog members on the base 112 is in part determined by what degree of granularity or precision is provided in terms of adjustability or fixation of the fastener as described in greater detail herein. Thus, in the illustrated embodiment, a large number of cog members are positioned about the base 112 where pairs of adjacent cog members are separated by a space, e.g., analogous to how the first cog member 116 is adjacent to the second cog member 118 and is separated therefrom by the space 120. That is, in some embodiments, a pattern repeats circumferentially around the base 112 (e.g., entirely around the base), as a cog member, space, cog member, space, cog member, space, etc., to set a desired granularity of precision.

Referring to FIG. 2B, an alternative fastener cap configuration is illustrated. The fastener cap 102 in FIG. 2B includes elements that are analogous or identical to the elements of the fastener cap 102 of FIG. 2A. As such, like elements are illustrated with like reference numerals, and the description of FIG. 2A is incorporated into the description of FIG. 2B except as otherwise noted.

In FIG. 2B, the fastener cap 102 is provided as at least two individual components. For instance, the base 112 can be physically separate from a cap portion (the cap portion designated by the housing 104 in FIG. 2B). This allows the cog members of the base 112 to be positioned and adjusted independent of the corresponding cap portion/housing 104. This also allows an attachment mechanism of the base 112 to be the same as, or different from, that of the cap portion/housing 104 of the fastener cap.

In this regard, the cap portion of the fastener cap 102 can push onto a corresponding lug nut or other fastener, and secure thereto, such as by a friction fit. In other embodiments, the fastener cap 102 may threadably screw on, snap onto, clip onto or otherwise secure to a corresponding fastener. Likewise, the base 112 can push onto a corresponding lug nut or other fastener, and secure thereto, such as by a friction fit. In other embodiments, the base 112 may threadably screw on, snap onto, clip onto or otherwise secure to a corresponding fastener. In this regard, the manner in which the cap portion of the fastener cap 102 secures to the fastener can be the same as, or different from the base 112.

For instance, the base 112 can include a threaded internal cavity, e.g., to thread onto the lug bolts. The cap portion of the fastener cap (e.g., illustrated via the housing 104) can then either seat over an existing lug nut installed over the base 112, or the cap portion (housing 104) can function as the lug nut, e.g., by threading onto the lug bolt independent of the base 112.

Hub

The hub 122 (see FIG. 1) has a port that cooperates with the fastener cap 102. The hub further comprises a locking member that constrains radial movement of the fastener cap by a projecting member disposed in the spatial gap between adjacent cog members of the fastener cap 102. For instance, the locking member can be positioned adjacent to the port. In an example implementation, the fastener cap is seated over a lug nut. The hub is then oriented such that the port aligns with the fastener cap. The hub is then axially traversed towards the fastener cap such that the fastener cap extends through the port, and the locking member on the hub aligns with the base of the fastener cap. In this configuration, installation of the hub over the fastener cap causes the projecting member of the locking member to dispose in a space between adjacent cogs. Accordingly, the fastener cap is prevented from rotation or other radial movement by the locking member. Once locked, movement of a corresponding fastener may be limited to the size of the space between adjacent cog members, the size of the projecting member of the locking member, combinations thereof, etc. Thus, a tight tolerance in the cooperation of the projecting member and the corresponding space between cog members will result in virtually no ability to rotate, or the sizing of the space between adjacent cog members and the projecting member can be coordinated to achieve a desired effect with regard to allowable rotation range of a corresponding locked fastener.

In applications requiring more than one fastener cap 102, the hub 122 is adapted with a corresponding number of ports and corresponding locking members, as will now be described.

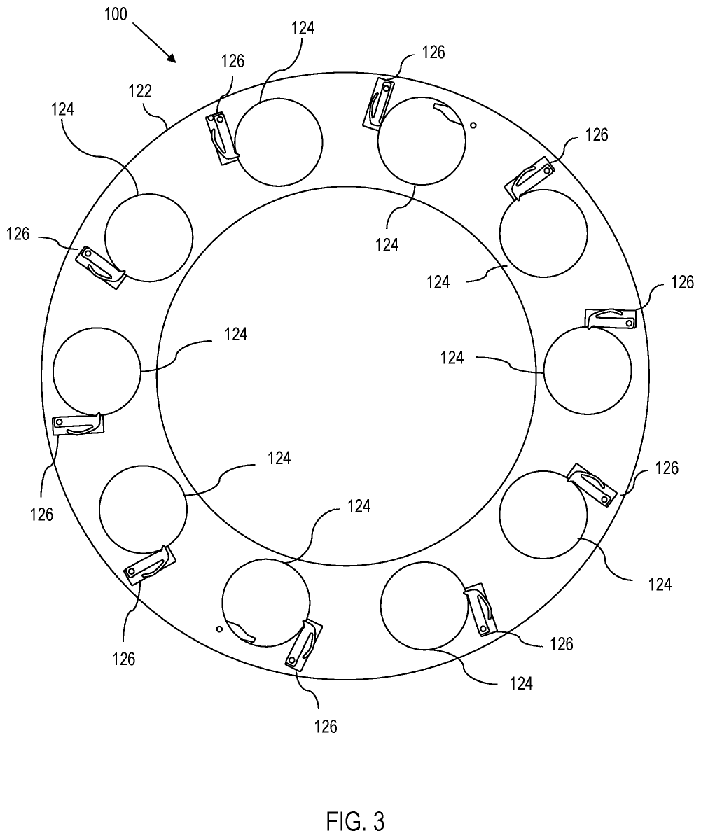

Referring now to FIG. 3, a bottom-up view illustrates a hub 122 according to aspects herein. As illustrated, the hub 122 is configured in a disc shape with a hole punched out at a center portion of the hub 122, thus defining an annular ring. The hub 122 comprises a port 124 that receives the fastener cap (see e.g., fastener cap 102 in FIG. 2A). In embodiments where multiple fastener caps 102 are implemented, the hub 122 can be configured with additional ports 124. For instance, a set of ports 124 are arranged in an array as shown in FIG. 3. However, virtually any arrangement of ports 124 can be implemented. In an example embodiment, the arrangement, sizing, number and placement of ports 124 will correspond to the fasteners in an intended application. For instance, in an example application for use with a vehicle tire system with eight lug bolts extending outward from a hub flange in a circular pattern that aligns with lug openings in a corresponding wheel rim, the hub 122 includes eight ports 124 positioned, sized and arrayed in a circular pattern that also corresponds to the lug openings of the corresponding wheel rim. As another example, the illustrated hub 122 includes ten ports that are positioned, sized and arrayed in a circular pattern to align with lug openings in a corresponding wheel rim suited for ten lug bolts.

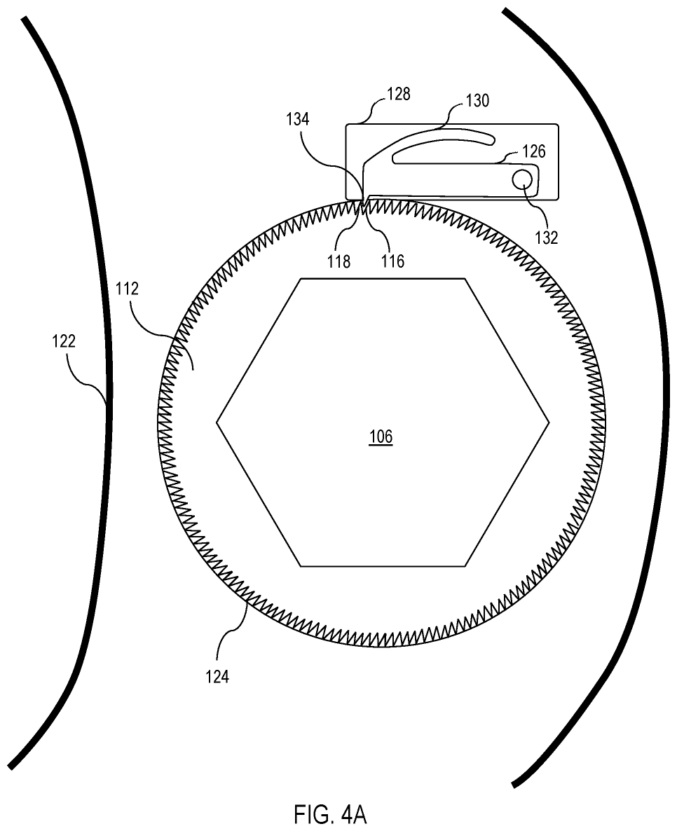

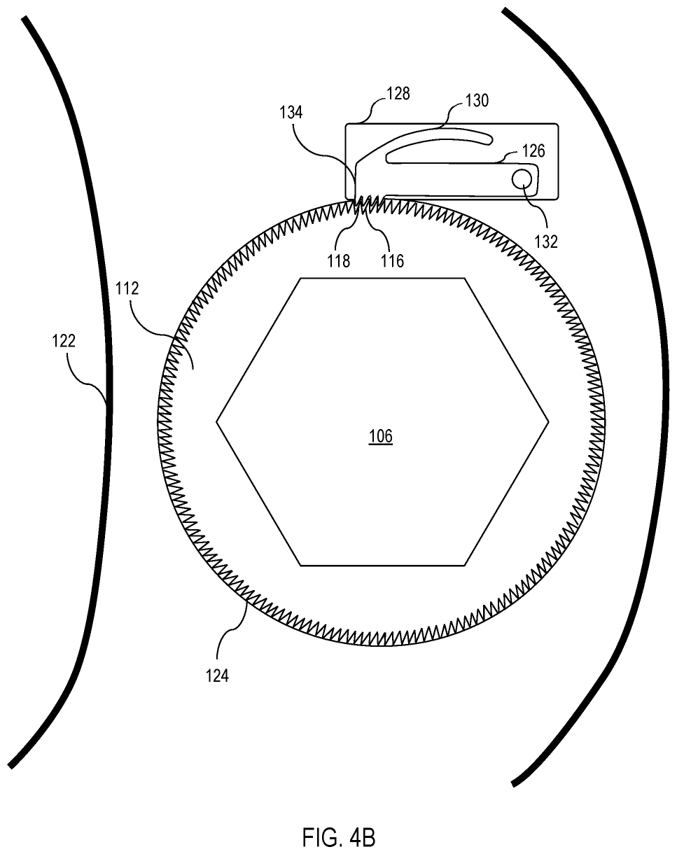

The hub 122 also includes one or more locking members 126 that constrain rotational movement of a corresponding fastener cap, as will be shown in greater detail in FIG. 4A-FIG. 4B. Analogously to the port(s) 124, the number of locking members 126 correspond to how many fasteners need to be retained/secured (e.g., in an array as shown in FIG. 3). Thus, in the example of eight ports 124, there are eight corresponding locking members 126. In the illustrated example, there are ten ports 124, thus there are ten corresponding locking members 126, etc.

As illustrated, the locking members 126 are provided on a bottom side of the hub 122. However, the locking members 122 can also be provided on the top side, e.g., depending upon the application.

Referring to FIG. 4A, a close-up view illustrates a fastener cap 102 interacting with a corresponding locking member 126. More specifically, the base 112 of the fastener cap 102 is shown interacting with the locking member 126.

In various embodiments, the locking member 126 is recessed in a hub cavity 128 within the hub 122, thereby lowering an overall profile of the hub 122. In various embodiments, the locking member 126 comprises a tension member 130, a pivot mechanism 132 (e.g., a pin or spring), and a projecting member 134 that slots (e.g., ratchets) into a space between adjacent cog members. In the illustrative example embodiment, the cog members 116 and 118 are disposed at an offset angle, e.g., the first cog member 116 and the second cog member 118 extend from the base at an offset angle. Moreover, the projecting member 134 extends from the locking member 126 at an angle that corresponds to the offset angle of the first cog member 116 and the second cog member 118 so as to allow the projecting member 134 to ratchet between the first cog member 116 and the second cog member 118. In this manner the projecting member 134 will ratchet with regard to any of the adjacent pairs of cog members disposed along the base 112.

By way of illustration, the projecting member 134 is disposed in the spatial gap between the first cog member 116 and the second cog member 118 (see e.g., spatial gap 120 in FIG. 2), which constrains angular movement (i.e., rotational movement) of the fastener cap 102. As a result, any fastener (e.g., lug nut) that the fastening cap 102 is covering, which would occupy the internal cavity 106 in FIG. 4A, is also angularly constrained. One benefit of such a configuration is that a user can further tighten the fastener via the fastening cap 102 without the fastener backing out.

For example, if a user wants to further tighten a fastener that is covered by the fastener cap 102 (i.e., the fastener is within the internal cavity 106), the user rotates the fastener cap 102 counter-clockwise (based on bottom-up perspective of FIG. 4A), which causes the locking member 126 to pivot via the pivot mechanism 132 and put tension on the tension member 130 as the projecting member 134 ascends the first cog member 116. Once the projecting member 134 passes the first cog member 116, the tension from the tension member 130 causes the projecting member 134 to fall between a new pair of cog members. This process can be repeated for successive cog members until the user has reached a desired setting.

In this regard, other types of mechanisms can be used in place of the tension member 130 and the pivot mechanism 132. For example, if the cog members 116 and 118 are linearly extruded, the locking member 126 (and by extension the projecting member 134) can be fixed in position (e.g., screwed, riveted, etc.). Instead of the tension member 130 being implemented as a flex bar, a spring could be used, and so on.

Referring now to FIG. 4B, a close-up view illustrates a fastener cap 102 interacting with a corresponding locking member 126 according to further aspects herein. The illustrated configuration is analogous to the configuration of FIG. 4A. As such, like elements are illustrated with like reference numbers. In this regard, for sake of conciseness, the disclosure of FIG. 4A is incorporated into the disclosure of FIG. 4B unless otherwise noted. In particular, the embodiment of FIG. 4B differs from the embodiment of FIG. 4A in that the locking member 126 includes a set of projecting members 134. For instance, two or more projecting members 134 can be implemented, each projecting member 134 configured to position between an adjacent pair of cog members. In this regard, the projecting members 134 can be positioned in adjacent spaces, or there can be gaps between the projecting members 134 and their corresponding cog pairs.

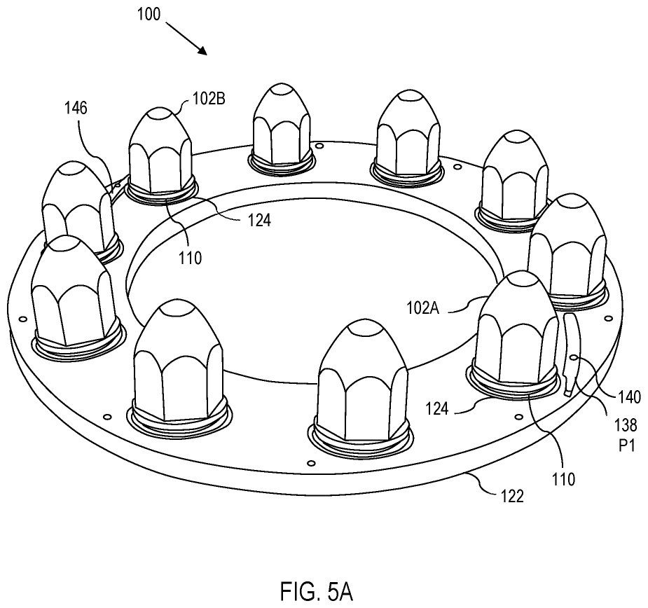

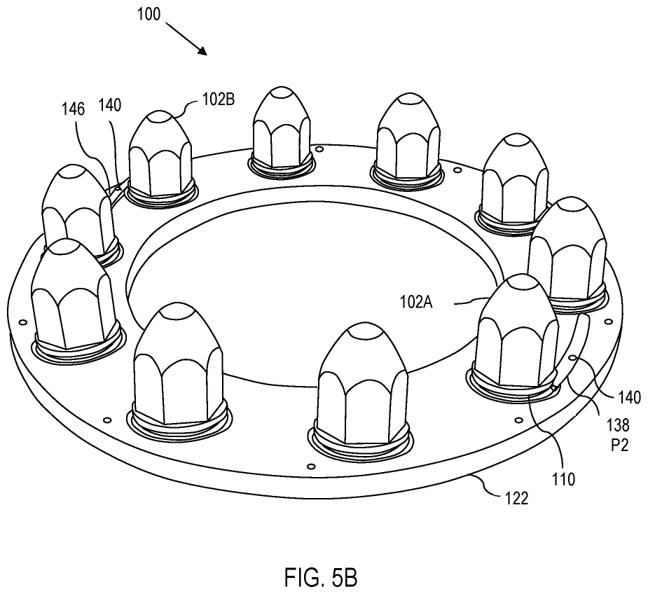

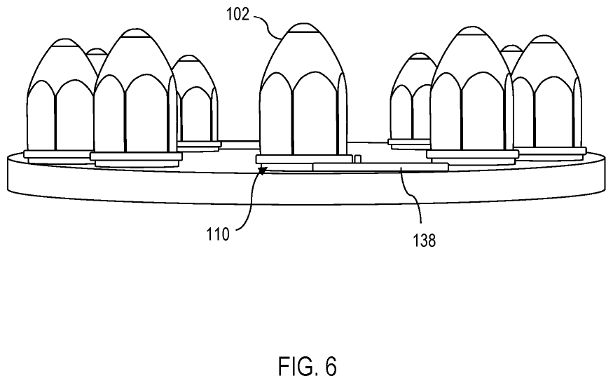

Turning now to FIGS. 5A, 5B, and 6 generally, an embodiment of the faster retainer 100 further comprises the use of a securement to detachably connect the hub 122 to one or more fastener caps 102. In this regard, the securement is implemented with one or more stop levers. For instance, as illustrated, two stop levers are utilized, including an optional first stop lever 138 that engages the stop channel 110 of a select one of the fastener caps 102 (designated as fastener cap 102A) and a second stop lever 146 that engages the stop channel 110 of a another select one of the fastener caps 102 (designated as fastener cap 102B). Each stop lever, e.g., the first stop lever 138 and the second stop lever 146 are secured to the hub 122 by a pin 140, which allows the respective stop lever to pivot relative to the pin 140. Moreover, each stop lever can be spring biased, or otherwise biased into a set position.

The first stop lever 138 and the second stop lever 146 can be positioned generally on opposite sides of the hub 122. In practice any number of stop levers can be provided. Also, it is not necessary that the second port/second stop lever opposes the first port/first stop lever, but opposing/symmetrical configurations may be utilized.

The first stop lever 138 is illustrated in a first position (P1 on FIG. 5A, e.g., an unlocked position) and a second position (P2 on FIG. 5B, e.g., a locked position). While in the first position P1 (FIG. 5A), the first stop lever 138 is not contacting the stop channel 110. The second stop lever 146 is obstructed from view, but assume that the second stop lever 146 is also in an analogous first position P1. This allows a user to remove the hub 122 from the lug caps 102, e.g., by pulling the hub 122 axially over the fastener caps 102.

While in the second position P2 (FIG. 5B), as noted above, the stop lever 138 engages the stop channel 110 of its corresponding fastener cap 102A. Again, the second stop lever 146 is obstructed from view, but assume that the second stop lever 146 analogously engages the stop channel 110 of its corresponding fastener cap 102B. Here, a bias can automatically transition the first stop lever 138 and the second stop lever 146 to the second position P2, or a user may manually set the first stop lever 138 and the second stop lever 146 to the second position P2. Regardless, the first stop lever 138 and the second stop lever 146 cooperate with corresponding fastener caps 102A and 102B, thereby constraining translational movement of the hub 122 relative to the fastener caps (e.g., at least relative to faster cap 102A and fastener cap 102B). Thus, the first stop lever 138 and stop lever 146 cooperate to hold the hub 122 relative to the fastener caps 102.

Referring briefly to FIG. 6, a front view of the fastener retainer 100 illustrates the stop lever 138 in the second position, engaging a stop channel 110 of a corresponding fastener cap 102.

With reference to the FIGURES generally, the combination of the locking member(s) and the stop lever(s) prevents each fastener from backing out and/or disengaging from its position, e.g., via vibration or other environmental causes.

In practice, some embodiments can utilize one stop lever or a set of stop levers, e.g., at least one stop lever associated with at least one corresponding fastener cap to secure the hub 122 to a corresponding tire assembly. In other embodiments, different securements are utilized to couple the hub 122 to the associated fastener caps 102 and/or tire assembly. For instance, in an example embodiment, the hub 122 can be positioned over lug bolts, and can be secured to a corresponding wheel hub via threaded fasteners, screws, brackets, etc. The hub 122 can attach to an axle nut or other tire system component.

In yet another illustrative embodiment, e.g., where the fastener caps 102 are provided in two component form, such as illustrated in FIG. 2B, the base can be slipped, pressed, threaded, or otherwise attached to the lug bolt (or lug nut). The hub 122 is then slipped over the base, and then the cap portion of the fastener cap is pushed, threaded, or otherwise coupled to the lug bolt or lug nut such that the cap portion secures the hub 122 in place. For instance, as illustrated in FIG. 2B, the extruded portion 114 (e.g., a flange) can be positioned somewhere along the housing 104 so as to create an abutment with the surface of the hub adjacent to a corresponding port. That is, the flange can be larger in diameter than a port diameter. Thus, when a cap portion is coupled to a fastener, the flange overlaps the associated port and prevents the hub 122 from pulling away from the tire assembly. Other mechanisms of securing the hub 122 to the fastener caps 102 or components of the tire assembly can be implemented.

Referring to FIG. 1-FIG. 6 generally, in an example embodiment, a hub 122 can include an array of ports 124. For typical lug nut/tire applications, the number of ports will typically be four, five, six, eight, or ten. However, in practice, any number of ports 124 can be provided, depending upon the application. An array of fastener caps 102 are provided that “numerically correspond” to the array of ports 124. That is, if there are ten ports 124, then ten fastener caps 102 are provided. If there are five ports 124, then five fastener caps 102 are provided, etc. As noted more fully herein, each fastener cap 102 in the array of fastener caps can comprise a housing 104 having an internal cavity 106 that dimensionally corresponds to a fastener, e.g., lug nut in this example. A stop channel 110 encircles the housing 104, and a base also encircles the housing 104. Here, the base 112 further comprises a first cog member 116, a second cog member 118, and a spatial gap 120 between the first cog member 116 and the second cog member 118 (in practice, there may be a set of cog members interleaved with a set of spaces). An array of locking members 128 are provided that numerically correspond to the array of fasteners caps 102. That is, there is a locking member 128 for each fastener cap 102. As such, each locking member 128 in the array of locking members constrains radial movement of a corresponding fastener cap 102 by using a projecting member 134 disposed in the spatial gap 120 between adjacent cog members, e.g., a first cog member 116 and a second cog member 118. Moreover, in some embodiments, one or more stop levers 138 can be provided. Each stop lever 138 engages the stop channel 110 of a corresponding fastener cap 102, thereby constraining translational movement thereof.

Hub Cap Assembly

As described herein, the fastener retainer 100 has broad applicability in industries that utilize motor vehicles. For motor vehicles that travel long distances, such as semi-trucks with a trailer, wear and tear of vehicle tires along with fuel efficiency contribute to costs of operating the motor vehicle.

Hub caps with aerodynamic geometry can provide increased fuel efficiency for a motor vehicle by limiting wind drag on wheels of the motor vehicle (e.g., rim, tires, etc.). However, geometries of the hub caps can also cover or obscure components of the vehicle tires such as lug nuts and tire stems (used to inflate or deflate tires). As a result, an operator of the motor vehicle may need to remove the hub cap to inspect the lug nuts and change tire pressure (i.e., inflate, deflate), thus increasing time and labor costs.

Unexpectedly however, by obviating the need to inspect the lug nuts (as e.g., because of the fastener retainer as described more fully above) and providing access to the tire stems, aspects of the present disclosure allow the operator of the motor vehicle to retain the advantages of the hub cap while mitigating or eliminating the need to remove the hub cap as described in greater detail herein. Further, aspects of the present disclosure also provide for a hub cap that balances tires while the motor vehicle is in motion by implementing various balancing media (e.g., into the hub cap) as described herein.

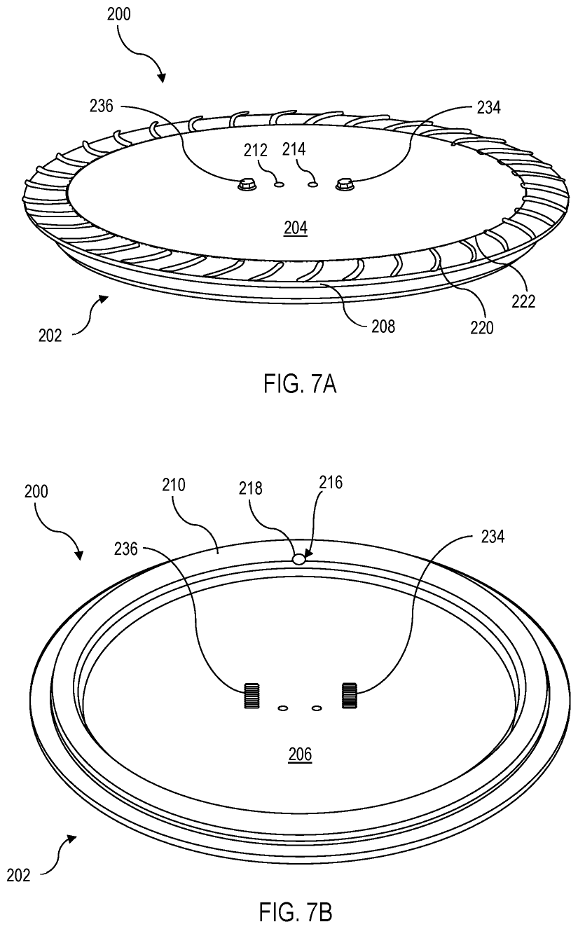

Referring now to FIGS. 7A-B, an example hub cap assembly 200 is illustrated. FIG. 7A illustrates the hub cap assembly 200 from the top, and FIG. 7B illustrates the hub cap assembly 200 from the bottom.

The hub cap assembly 200 further comprises a rim 210 that extends from the bottom surface 206. For instance, as illustrated, the rim 210 extends orthogonally in relation to the bottom surface 206 of the disc 202. Thus, in the illustrated embodiment, the rim 210 is hidden from view when mounted on a tire system. The rim 210 will be described in greater detail below.

The hub cap assembly 200 also includes a first tire stem port 212 disposed on the disc 202. Moreover, in some embodiments, such as that illustrated, the hub cap assembly 200 can include a second tire stem port 214 disposed on the disc 202. The second tire stem port 214 is convenient for dual wheel configurations, where two tires are mounted adjacent to one another on a corresponding axle. The first stem port 212 and the (optional) second stem port 214 allow a user to access tire stems of tires for inflation, deflation, inspection, or a combination thereof. In some embodiments, the tire stems on corresponding tires may not reach to the first tire stem port 212 and/or second tire stem port 214. In this regard, tire stem extenders (not shown) are coupled between the tire stem of a first tire and the first tire stem port 212, and analogously, between the tire stem of a second tire and the second tire stem port 214. Using the first tire stem port 212 and optional second tire stem port 214, the user does not have to remove the hub cap assembly 200 to change or inspect the pressure of the tires of the motor vehicle.

Although illustrated as being generally centered within the top surface 204, in practice the first tire stem port 212, and/or the optional second tire stem port 214 can be located in other positions relative to the disc 202, so long as the first tire stem port 212 and the optional second tire stem port 214 allow access to corresponding tire stems (or tire stem extenders) without the need to remove the hub cap assembly 200.

As best illustrated in FIG. 1B, the rim 210 comprises a rim cavity 216. The rim cavity is configured to store, contain, or is otherwise configured to receive balance media. In some embodiments, balance media can be added (and in some cases removed) via an access port 218 on the rim 210. In some embodiments, the access port is positioned on the rim 210. In other embodiments, the access port 218 can extend from the rim 210 (e.g., along or through) the disc 202 to provide a convent access location. For instance, in some embodiments, the access port 218 is channeled to the front surface 204 (or intermediate layer 206) so that balance media can be adjusted without the need to remove the hub cap assembly 200.

In the example embodiment, the rim 210 is illustrated as a channel or passage that extends orthogonally from the bottom surface 206, inset from an outer edge of the bottom surface 206. This allows the rim 210 to be concealed when installed on a tire assembly. Moreover, the rim 210 forms an annular ring shape having a hollow therein for containing balance media. Moreover, as illustrated, the annular ring shape is coaxial with a center of the disc 202. In practice however, the rim 210 can take on other configurations. For instance, the rim 210 can be concealed within the disc 202. Alternatively, in some embodiments, the rim 200 can extend from or otherwise engage the front surface 204 of the disc 202, such as to facilitate access to balance a tire system.

Tires, and in particular, semi-truck tires experience significant amount of force. For example, radial forces, vibrational forces, harmonic forces all influence tire performance. Moreover, where there are two (or more) tires mounted to each axle end, such as common in semi-trucks, small mismatches in tread depth, air pressure, and other factors can affect tire balance. Out of balance tires can cause vibration, noise, decreased fuel economy, etc. However, aspects herein provide balancing in the hub cap assembly 200.

Balance media generally refers to compositions and/or mechanisms that counteract tire related issues from unbalanced tires such as wobbling tires, vibrations, higher operating temperatures, higher fuel consumption, etc. Examples of balance media include tire balance liquids and tire balancing beads among other things. In some implementations, the hub cap assembly 200 includes the balancing media built in. As such, an access port 218 is not necessary. However, the access port 218 may be included on such implementations to allow a user to change, update, etc., the balancing media.

In other embodiments, balance media can be installed in another portion of the hub cap assembly 200 (e.g., in a separate chamber disposed inside a circumference of the rim 210) as opposed to inside the rim 210. Regardless, aspects herein provide for tire balancing to be carried out in the hub cap assembly 200, thus eliminating the need to modify the tires directly.

In some embodiments, the top surface 204 can be smooth and continuous. However, in other embodiments, the hub cap assembly 200 further comprises cooling fins 220 disposed about a circumference 222 of the top surface 204. The cooling fins 220 redirect air to portions of the tire (or components coupling the tire to the vehicle), which allows the tire (and/or other components coupling the tire to the vehicle) to operate at a lower temperature, thereby extending tire life. For instance, the cooling fins 220 can direct cooling air to the bead of a tire. The geometry of the cooling fins 220 shown in FIG. 7A is by way of example only. Other geometries may be implemented (e.g., scallops in the rim, air channels, etc.), and the geometry of the cooling fins determines which position(s) on the tire, rim, components coupling the tire to the vehicle, etc. that the cooling air is directed to and how much air is directed to that position(s). Moreover, the cooling fins 220 do not all need to be the same geometry; multiple different geometries of cooling fins 220 may be present on one hub cap assembly 200.

The hub cap assembly 200, when combined with a fastener retainer (discussed below) allows the user of the motor vehicle to retain the benefits of hub caps in general (e.g., increased fuel efficiency through aerodynamics) without any time and labor costs associated with removing the hub cap assembly 200.

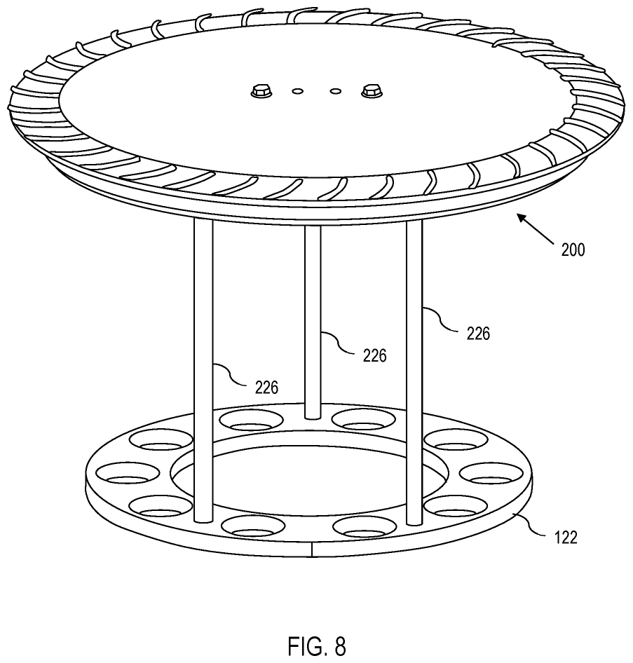

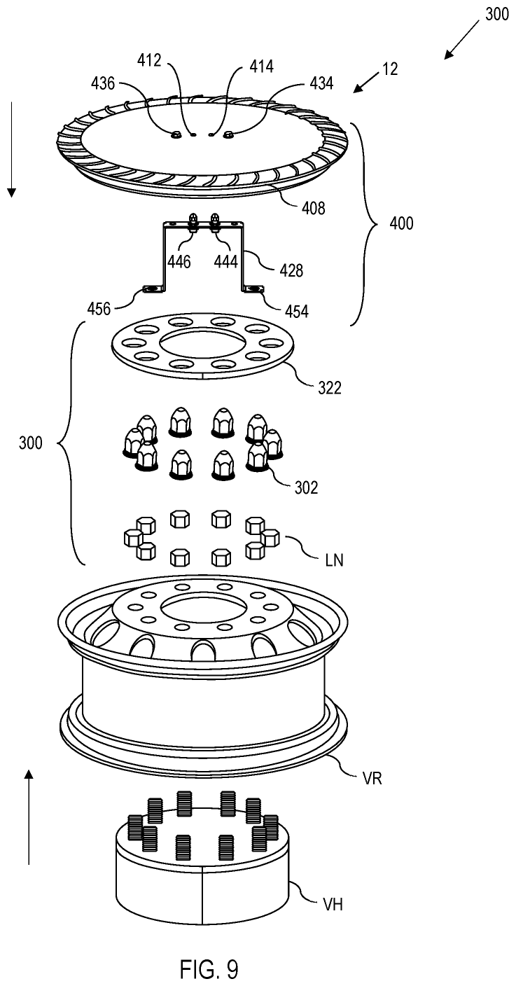

Referring to FIG. 8, in various implementations, the hub cap assembly 200 further comprises a support member 226 that extends orthogonally in relation to the bottom surface 206. In FIG. 8, for example, the support member 226 is implemented as three vertical pillars that couple to a hub of a fastener retainer (discussed in greater detail below). Also, as shown in FIG. 8, the support members 226 are integrated with the disc 202. However, in other embodiments, the support members 226 are coupled to the disc 202 via couplers (e.g., screws, bolts, etc.). For example, in FIGS. 7A-B, two bolts 234, 236 are shown to couple the disc 202 to support members 226. Moreover, the support members 226 may have portions integrated with the disc and other portions coupled to the disc via fasteners. For example, the support members 226 shown in FIG. 8 may be used in conjunction with the support member 428 of FIG. 9, discussed below.

In some embodiments, the support member is implemented as pillars that couple directly to fastener caps of the fastener retainer (e.g., pillars that go over the fastener cap and snap into the stop channel of the fastening cap) as described in greater detail herein. Further, the support members can couple to a rim of the vehicle.

In other embodiments, the hub cap assembly 200 can be coupled to a corresponding axle, lug bolts, lug nuts, or other tire system component(s) using a bracket, such as a U-shaped bracket or bracket of other suitable configuration.

In some embodiments, the hub cap assembly 200 sets within a tire rim, e.g., within the wheel disc cavity. In other embodiments, the hub cap assembly 200 can take other shapes as desired for a particular application.

Modular Tire System

Referring to FIG. 9, the fastener retainer and the hub cap assembly when used together comprise a modular tire system 300. Starting from the bottom of FIG. 9, a vehicle hub (“VH” in FIG. 9) is illustrated. For sake of example, the vehicle hub VH has ten lugs extending therefrom in a circular array. The vehicle hub in FIG. 9 is simply a stand-in for any typical hub and is by no means limiting.

In the example implementation, a vehicle rim (VR) seats over the vehicle hub VH. In this example, the vehicle rim VR includes ten apertures, each aperture axially aligning with an associated lug of the vehicle hub VR. For sake of simplicity of explanation, a tire is omitted. In practical applications, a tire is mounted to the vehicle rim VR.

Moreover, lug nuts (LN) are used to secure the vehicle rim VR to the vehicle hub VH. There is typically one lug nut for each lug of the vehicle hub.

A fastener retainer 300 is installed over the vehicle rim VR to secure the lug nuts LN. The fastener retainer 300 is analogous to the fastener retainer 100 described with reference to FIG. 1-FIG. 6. As such, structures, embodiments, and variations described with reference to the fastener retainer 100 are adopted and applied to the fastener retainer 300.

By way of summary and example, a fastener cap 302 is installed over each lug nut. As illustrated, there are a set/array of fastener caps in FIG. 9 (e.g., ten fastener caps 302, corresponding to ten lugs/lug nuts. The fastener caps 302 in FIG. 9 are analogous to the fastener caps 102 of FIG. 1-FIG. 6, including embodiments and variations thereof. As such, structures, embodiments, and variations described with reference to the fastener caps 102 are adopted and applied to the fastener caps 302.

The fastener caps 302 seat over corresponding lug nuts LN and feed through corresponding ports of a hub 322. The hub 322 is analogous to the hub 122 described with reference to FIG. 1-FIG. 6. As such, structures, embodiments, and variations described with reference to the hub 122 are adopted and applied to the hub 322. By way of example, the hub 322 can incorporate locking members that constrain radial movement of corresponding fastener caps (e.g., by a projecting member disposed in a spatial gap between adjacent cog members on the fastener cap housing as described more fully herein. The hub 322 can also optionally include one or more stop levers, each stop lever engaging a corresponding stop channel of an associated fastener cap, thereby constraining translational movement of the fastener cap, as described more fully herein.

FIG. 9 also illustrates a hub cap assembly 400 attached to the fastener retainer 300. The illustrated hub cap assembly 400 is analogous to the hub cap assembly 200 described with reference to FIGS. 7A, 7B, and 8. As such, structures, embodiments, and variations described with reference to the hub cap assembly 200 are adopted and applied to the hub cap assembly 400.

By way of example, a support member 428 couples the hub cap assembly 400 to the fastener retainer 300. In this regard, the support member 428 is another embodiment of the support members 36 described with reference to FIGS. 7A, 7B, and 8. As such, structures, embodiments, and variations described with reference to the support member 226 are adopted and applied to the support member 428.

In various embodiments, the support member 428 is implemented as a bracket (e.g., a top hat bracket), which can couple, for example, to the vehicle hub VH. In certain embodiments, the top hat bracket is wide enough to mount directly to the hub 322 as opposed to the vehicle hub VH. Alternatively, the support member 428 can be implemented as described herein (e.g., see FIG. 8 where support members 226 implemented as vertical pillars integrated with the disc 202). In FIG. 9, the support member 226 also includes two couplers 444, 446 that couple to tire stems of the tires. These couplers 444, 446 align with the tire stem ports 212, 214 of the disc 202 to allow a user to have access to the tire stems of the tire to adjust and/or detect tire pressure. As discussed above, the support members 226 may be directly integrated with the disc 202, coupled to the disc with fasteners 434, 436. Further, in some embodiments, the bracket support member 428 may include apertures 454, 456 for coupling to the vehicle rim VR, the fastener retainer 300, or both.

In an example installation of the system 300, the vehicle rim VR fits over the vehicle hub VH, where the lug nuts LN of the vehicle hub VH protrude through ports on the vehicle rim VR. The array of fastener caps 302 fasten to the lug nuts, and the hub 322 couples to the array of fastener caps 302 (e.g., via the stop levers 138 and 146 in FIGS. 5A and 5B). The hub cap assembly 400 couples to the support member 328, which is ultimately coupled to the vehicle hub (or other suitable anchor point).

The system 300 provides numerous advantages. When installed, the system 300 allows a user to benefit from the features of the hub cap assembly 200, 400 (e.g., aero dynamics, balancing, cooling, etc.) and still access internal components of the motor vehicle tire (e.g., air valve stems to inflate/deflate the tires) without removing the hub cap assembly 400.

In this regard, the system 300 minimizes downtime associated with inspecting and maintaining equipment. In addition, in embodiments where the hub cap assembly 400 utilizes cooling fins and/or balancing media, the user of the motor vehicle can further extend life of their equipment (tires, etc.) and reduce time and labor associated with repairing or replacing equipment.

Another benefit of the system 300 is that components thereof are swappable or may be omitted based on the motor vehicle that the system 300 is being used on. For example, the user may have a tire/vehicle rim VR that can couple to the hub cap assembly 400 without the support member 428. In such a case, only the fastener caps 302, hub 322, and the hub cap assembly 400 may need to be installed.

Separability of the components also makes replacement of parts easier for the user of the motor vehicle. Accordingly, the user can simply remove the broken component and replace it without having to replace the other components.

Miscellaneous

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A fastener retainer comprising:
a fastener cap comprising:
a housing having an internal cavity that dimensionally corresponds to a fastener; and
a base that encircles the housing, wherein the base further comprises a first cog member, a second cog member, and a spatial gap in between the first cog member and the second cog member; and
a hub having a port that receives the fastener cap, wherein the hub further comprises a locking member that constrains radial movement of the fastener cap by a projecting member disposed in the spatial gap.

2. The fastener retainer of claim 1, wherein:
the first cog member and the second cog member extend from the base at an offset angle; and
the projecting member extends from the locking member at an angle that corresponds to the offset angle of the first cog member and the second cog member so as to allow the projecting member to ratchet between the first cog member and the second cog member.

3. The fastener retainer of claim 1, wherein:
the locking member is recessed within the hub.

4. The fastener retainer of claim 1, wherein:
the locking member is a ratcheting mechanism.

5. The fastener retainer of claim 1, wherein:
the locking member is coupled to the hub by a pin.

6. The fastener retainer of claim 1, wherein:
the hub further comprises a stop lever that engages a stop channel of the fastener cap, thereby constraining translational movement of the hub relative to the fastener cap.

7. The fastener retainer of claim 1, wherein:
the hub further comprises a second port that opposes the first port;
the fastener cap defines a first fastener cap; and
a second fastener cap couples to the hub via the second port.

8. The fastener retainer of claim 7, wherein the hub further comprises:
a first stop lever that engages a stop channel of the first fastener cap; and
a second stop lever that engages a stop channel of the second fastener cap;
thereby constraining translational movement of the hub relative to the first fastener cap and the second fastener cap.

9. The fastener retainer of claim 1, wherein:
the hub is configured to accommodate at least four total fastener caps.

10. The fastener retainer of claim 9, wherein:
the internal cavity of each of the at least four fastener caps is dimensioned to seat over a corresponding lug nut of a tire assembly.

11. The fastener retainer of claim 1, wherein:
the internal cavity is dimensionally configured to engage a six-sided fastener.

12. The fastener retainer of claim 1, wherein:
the internal cavity further comprises extruded channels that extend vertically along the internal cavity.

13. The fastener retainer of claim 1, wherein:
the fastener cap is comprised of an onyx and/or fiber-filled plastic nylon.

14. A fastener retainer comprising:
a hub having an array of ports;
an array of fastener caps that numerically correspond to the array of ports, wherein each fastener cap in the array of fastener caps comprise:
a housing sized to cooperate with an associated one of the ports in the array of ports of the hub; and
a base that encircles the housing, wherein the base further comprises a first cog member, a second cog member, and a spatial gap in between the first cog member and the second cog member; and
an array of locking members that numerically correspond to the array of fasteners caps, wherein each locking member in the array of locking members is coupled to the hub adjacent to an associated port, and constrains radial movement of a corresponding fastener cap by disposing a projecting member in a spatial gap between the first cog member and the second cog member on the base of the corresponding fastener cap.

15. The fastener retainer of claim 14, wherein:
each fastener cap in the array of fastener caps further comprises a stop channel that encircles the housing above the corresponding base; and
the hub supports at least one stop lever, each stop lever adjacent to an associated fastener cap.

16. The fastener retainer of claim 14, wherein:
for each fastener cap in the array of fastener caps, the first cog member and the second cog member extend from the base at an offset angle; and
the projecting member extends from the locking member at an angle that corresponds to the offset angle of the first cog member and the second cog member so as to allow the projecting member to ratchet between the first cog member and the second cog member.

17. The fastener retainer of claim 14, wherein:
each locking member in the array of locking members is recessed within the hub adjacent to an associated port.

18. A fastener retainer for a tire, comprising:
a hub having at least four ports;
a fastener cap uniquely associated with each of the at least four ports, wherein each fastener cap comprises:
a housing that inserts into the corresponding one of the at least four ports;
a stop channel that encircles the housing; and
a base that encircles the housing, wherein the base further comprises cog members that project from the base, where pairs of adjacent cog members are separated by a space;
a locking member uniquely associated with each of the at least four ports, wherein each locking member constrains radial movement of a corresponding fastener cap by disposing a projecting member into a select spatial gap between adjacent cog members; and
a stop lever coupled to the hub that engages the stop channel of a corresponding fastener cap, thereby constraining translational movement thereof.

19. The fastener retainer for a tire, according to claim 18, wherein each fastener cap includes an internal cavity that seats over a corresponding lug nut.

20. The fastener retainer for a tire, according to claim 18, wherein each fastener cap includes an internal cavity so as to function as a lug nut.
